(19) United States
(12) Patent Application Publication
(10) Pub. No.: US 2025/0162334 A1
(43) Pub. Date: May 22, 2025

(54) Inkjet printhead assembly having deflection angle and printing device

(71) Applicant: GuangZhou KingTau Machinery&Electronics Equipment Co., Ltd., Guangzhou (CN)

(72) Inventor: Zhenhua TANG, Guangzhou, Guangdong (CN)

(21) Appl. No.: 19/030,964

(22) Filed: Jan. 17, 2025

Related U.S. Application Data
(63) Continuation of application No. PCT/CN2022/142654, filed on Dec. 28, 2022.

(30) Foreign Application Priority Data
Jul. 22, 2022 (CN) 202210868197.5

(51) Int. Cl. B41J 25/316; B41J 2/165; B41J 25/00

(52) U.S. Cl. CPC B41J 25/316; B41J 2/16532; B41J 2025/008

(57) ABSTRACT

An inkjet printhead assembly having a deflection angle includes an inkjet printhead carrier and a plurality of inkjet printheads. The inkjet printheads are distributed in several rows in parallel on the inkjet printhead carrier, and the inkjet printheads in the two adjacent rows are staggered and overlapped. The inkjet printheads are mounted obliquely relative to the inkjet printhead carrier, and the several rows of inkjet printheads are arranged around an arc-shaped printing surface. Lower surfaces of the several rows of inkjet printheads are combined to form a recessed inkjet surface, and each surface of the inkjet surface is tangential with the arc-shaped printing surface.

### CROSS REFERENCE TO RELATED APPLICATIONS

The present application is a continuation of International Application No. PCT/CN2022/142654, filed on Dec. 28, 2022, which claims priority from Chinese Application No. 202210868197.5 filed on Jul. 22, 2022, all of which are hereby incorporated herein by reference.

### FIELD OF TECHNOLOGY

The present disclosure relates to the field of inkjet printers, in particular to an inkjet printhead assembly having a deflection angle, and a printing device.

### BACKGROUND

As known, an inkjet printer generally forms images or words by jetting ink to the surface of a printing medium with inkjet printheads thereof. Taking a single-pass printer as an example, inkjet printheads of the single-pass printer are fixed in a transverse direction perpendicular to the moving direction of the printing medium, and the printing medium is moved in a longitudinal direction. The printing medium is driven by an electric motor to move continuously at a high speed in the longitudinal direction while the inkjet printheads jet ink continuously, thereby achieving the high printing speed. The printing width of the single-pass printer usually depends on the length of the inkjet printheads arranged in the transverse direction, and the length of the inkjet printheads is determined by the number of nozzle orifices and the physical resolution thereof. In order to achieve wider printing width output to improve the inkjet printing efficiency, on one hand, wider inkjet printheads having high physical resolution can be used, but such inkjet printheads are generally expensive; and on the other hand, a plurality of inkjet printheads can be placed transversely in parallel to form an inkjet printhead array, with some of the inkjet printheads assembled in a staggered and overlapped manner, the total length of such inkjet printhead array defines the printing width. The latter configuration is widely used due to the advantage of low cost.

A roller type inkjet printer generally includes a roller, a linear movement platform, and an inkjet printhead assembly. The roller is located below the linear movement platform and the inkjet printhead assembly, and the surface of the roller is configured to wind and deliver a printing medium. The linear movement platform serves to drive the inkjet printhead assembly to adjust the distances between the inkjet printhead assembly and the printing medium. The inkjet printhead assembly includes an inkjet printhead array composed of a plurality of inkjet printheads and an inkjet printhead carrier for mounting the inkjet printhead array. When the printing medium passes below the inkjet printhead assembly, the fixed inkjet printhead assembly jets ink continuously to complete inkjet printing.

As shown in FIGS. 1 and 2, taking the roller type inkjet printer provided with the inkjet printhead assembly typically having two rows of inkjet printheads as an example, on one hand, the plurality of inkjet printheads are distributed in two rows in parallel in the length direction of the inkjet printhead carrier; each inkjet printhead in one row is partially overlapped with the two adjacent inkjet printheads in the other row simultaneously to make up a gap between the two adjacent inkjet printheads, that is, the inkjet printheads are mounted in staggered and overlapped way, thereby achieving assembly of the inkjet printheads in the length direction.

On the other hand, it is well known in the art that when the inkjet printheads jet ink, the inkjet direction should be perpendicular to the printing medium so as to achieve the highest printing quality. Therefore, when the inkjet printhead assembly is mounted relative to the roller, the inkjet direction should point to the circle center of the roller. However, as the inkjet printhead assembly has two rows of inkjet printheads, namely, having two parallel inkjet directions, when the inkjet direction of the inkjet printheads in one row points to the circle center of the roller, the inkjet direction of the inkjet printheads in the other row inevitably deviates from the circle center of the roller, thus the inkjet printheads in the other row cannot be perpendicular to the printing medium according to the prior art, thereby affecting the overall printing quality of the inkjet printhead assembly.

Therefore, for the roller type inkjet printer with multiple rows of staggered and overlapped inkjet printheads mounted, how to make the inkjet printheads in each row perpendicular to the printing medium (that is, make the inkjet directions point to the circle center of the roller) is the technical problem urgent to be solved in the prior art.

### SUMMARY

The present disclosure aims to overcome at least one defect in the prior art, and to provide an inkjet printhead assembly having a deflection angle and a printing device, which is free from the problem that multiple rows of staggered and overlapped inkjet printheads cannot be perpendicular to an arc-shaped printing surface simultaneously, thereby improving the overall printing quality of the inkjet printhead assembly.

The inkjet printhead assembly having a deflection angle according to the present disclosure includes an inkjet printhead carrier and a plurality of inkjet printheads mounted on the inkjet printhead carrier. The inkjet printheads are distributed in several rows in parallel on the inkjet printhead carrier, and the inkjet printheads in the two adjacent rows are staggered and overlapped. The inkjet printheads are mounted obliquely relative to the inkjet printhead carrier; and the several rows of inkjet printheads are arranged around an arc-shaped printing surface, lower surfaces of the several rows of inkjet printheads are combined to form a recessed inkjet surface, and each surface of the combined inkjet surface is tangential with the arc-shaped printing surface.

In this solution, a lengthwise direction of the inkjet printhead carrier is a front-and-back direction, a widthwise direction thereof is a left-and-right direction, and a height direction thereof is an up-and-down direction. A normal direction at the center of the lower surface of the inkjet printhead is generally taken as the inkjet direction of each inkjet printhead. The inkjet printheads in each row are mounted obliquely relative to the inkjet printhead carrier, thus the inkjet directions of the inkjet printheads in each row are inclined relative to a certain datum line of the inkjet printhead carrier, and the inkjet directions of the inkjet printheads in each row have different inclination angles. The several rows of inkjet printheads are arranged above the arc-shaped printing surface in a surrounding manner. The lower surfaces of the several rows of inkjet printheads are thus no longer in a common plane, and are combined into the recessed inkjet surface. When the inkjet printhead carrier drives the inkjet printheads to get close to the arc-shaped printing surface, and the distance between the lower surfaces of the inkjet printheads and the arc-shaped printing surface is zero, each surface of the combined inkjet surface is tangential with the arc-shaped printing surface. The inkjet surface is equivalent to a part of a circumscribed polygon of the arc-shaped printing surface. In the present disclosure, the inkjet printheads in each row are mounted at different inclination angles relative to the inkjet printhead carrier, so that the inkjet directions of the inkjet printheads can point to the circle center of the arc-shaped printing surface, the problem thus can be solved that the multiple rows of staggered and overlapped inkjet printheads cannot be perpendicular to the arc-shaped printing surface simultaneously, thereby achieving the effect of improving the overall printing quality of the inkjet printhead assembly.

The specific numerical values of the inclination angles can be obtained by the simplified relationship of the inkjet printhead carrier and the inkjet printheads. The inkjet printhead carrier has a first reference line which points to the circle center of the arc-shaped printing surface, nozzle orifices of each of the inkjet printheads have a second reference line which points to an inkjet direction of the nozzle orifices. The included angle between the first reference line and the second reference line defines a deflection angle φ, and the inkjet printheads are mounted obliquely at the deflection angle φ relative to the first reference line.

A calculation formula for the deflection angle φ is

$$φ = {tan}^{- 1} \frac{L + H tan a}{R + H} ,$$

wherein L refers to the distance between the nozzle orifices and the first reference line; H refers to the height from the inkjet printhead carrier to the arc-shaped printing surface; α refers to the included angle between a movement direction of the nozzle orifices and the first reference line; and R refers to the radius of the arc-shaped printing surface.

In this solution, the first reference line of the inkjet printhead carrier is used as the datum line, and the first reference line can be the center line of the inkjet printhead carrier. When the inkjet printheads are mounted obliquely at the deflection angle φ relative to the first reference line of the inkjet printhead carrier, all that is required to ensure that the inkjet directions of the inkjet printheads in each row point to the circle center of the arc-shaped printing surface is to make the first reference line point to the circle center of the arc-shaped printing surface, in such way the inkjet printheads in each row can be ensured to be perpendicular to the arc-shaped printing surface simultaneously. The second reference line starts from the center of the nozzle orifices of each inkjet printhead and points to the inkjet direction of the nozzle orifices. When the single inkjet printhead has a single row of nozzle orifices, the second reference line is the inkjet direction of the inkjet printheads in the row, and the deflection angle φ is the inclination angle at which the inkjet printheads in the row are mounted relative to the inkjet printhead carrier. When the single inkjet printhead has multiple rows of nozzle orifices, each row of the nozzle orifices has one second reference line, and thus a plurality of deflection angles φ will be calculated. Since the distances of the multiple rows of nozzle orifices are short, the average value of the deflection angles φ of the multiple rows of nozzle orifices or the deflection angle φ of the middle of the multiple rows of nozzle orifices can be calculated as the inclination angle at which the inkjet printheads in the row are mounted relative to the inkjet printhead carrier. Therefore, within the allowable range of errors, the inkjet directions of the multiple rows of nozzle orifices of the inkjet printheads in the row are nearly perpendicular to the arc-shaped printing surface.

In this solution, the height H from the inkjet printhead carrier to the arc-shaped printing surface changes in a certain range, and for the inkjet printheads in each row, a plurality of deflection angles φ can be calculated. Since the height H and the radius R of the arc-shaped printing surface differ by several orders of magnitude, the deflection angles φ thus change slightly, accordingly, within the allowable range of errors, the average value thereof can be taken as the inclination angle at which the inkjet printheads in the row are mounted relative to the inkjet printhead carrier. When the height H from the inkjet printhead carrier and the arc-shaped printing surface is zero, a lower surface of the inkjet printhead carrier and an imaginary extension surface thereof are tangential with the arc-shaped printing surface. The height H from the inkjet printhead carrier and the arc-shaped printing surface is equivalent to the working height of the inkjet printheads. Therefore, the distance L between the nozzle orifices and the first reference line should be the numerical value when the height H from the inkjet printhead carrier and the arc-shaped printing surface is zero. Besides, it should be noted that when the height H of the inkjet printhead carrier is adjusted, the inkjet printhead carrier may not necessarily move along the first reference line thereof. Accordingly, when the included angle α between the movement direction of the nozzle orifices and the first reference line is formed on the outer side of the arc-shaped printing surface, the included angle α is a negative value; and when the included angle α between the movement direction of the nozzle orifices and the first reference line is formed on the inner side of the arc-shaped printing surface, the included angle α is a positive value.

Preferably, according to the present disclosure, the ratio of the radius R of the arc-shaped printing surface to the distance L between the nozzle orifices and the first reference line is R/L≥10. For the inkjet printheads having multiple rows of nozzle orifices, the distances L between the nozzle orifices and the first reference line may include the minimum value L_{MIN} and the maximum value L_{MAX}. When the ratio of R to L is calculated, the distance L should be L_{MAX}; and further, it should be further met: R/(L_{MAX}−L_{MIN})≥20. On one hand, when the ratio of R to L differs by one order of magnitude, the difference of the numerical value of the calculated deflection angle φ of each row of the nozzle orifices of the single inkjet printhead will be small, therefore, the average value of the deflection angles φ of the multiple rows of nozzle orifices or the deflection angle φ of the middle of the multiple rows of nozzle orifices can be calculated as the inclination angle at which the inkjet printheads in the row are mounted relative to the inkjet printhead carrier. Accordingly, within the allowable range of errors, the inkjet directions of the multiple rows of nozzle orifices of the inkjet printheads in the row are nearly perpendicular to the arc-shaped printing surface. On the other hand, when the ratio of R to L differs by one order of magnitude, the distance of each row of nozzle orifices of the single inkjet printhead is also correspondingly small, thus the height of each row of nozzle orifices relative to the arc-shaped printing surface can be nearly equal, and thus the influence of the curvature of the arc-shaped printing surface on the inkjet quality of the inkjet printheads can be reduced.

Preferably, the numerical value of the included angle between the movement direction of the inkjet printhead carrier and the first reference line is |α|≤20°. When the inkjet printhead carrier is located at different heights H, the included angle α will affect the actual distance between the nozzle orifices of the inkjet printheads and the first reference line. When the included angle α is the positive value, the included angle α will increase the actual distance between the nozzle orifices and the first reference line; and when the included angle α is the negative value, the included angle α will shorten the actual distance between the nozzle orifices and the first reference line. Such influence will be increased with increase of the numerical value of the included angle α. Therefore, in the actual application, the numerical value of the included angle α should not exceed 20°, and the value range of the included angle α should be [−20°, 20° ].

Preferably, the deflection angle φ is in a range of 1° to 5°. According to the calculation formula of the deflection angle φ, the deflection angle φ is comprehensively affected by the distance L, the height H, the included angle α and the radius R. When the deflection angle φ of the nozzle orifices of the inkjet printheads relative to the first reference line is limited in the range of 1° to 5°, the influence on the inclination angles of the inkjet printheads 12 can be reduced that caused by the working height of the inkjet printhead carrier and the distribution condition of the nozzle orifices of the inkjet printheads. For example, for the inkjet printheads having the multiple rows of nozzle orifices, when the inkjet printheads are mounted obliquely at 3° relative to the inkjet printhead carrier, within the error range of 2°, any row of the nozzle orifices of the inkjet printheads can be deemed as perpendicular to the arc-shaped printing surface at any working height, and the inkjet directions thereof point to the circle center of the arc-shaped printing surface.

According to the present disclosure, the inkjet printheads are mounted obliquely relative to the inkjet printhead carrier in a way that the inclination angles therebetween are changing, that is, the inclination angles of the inkjet printheads relative to the inkjet printhead carrier can change with the deflection angle in different situations, and the inkjet printheads are connected to the inkjet printhead carrier by an automatic inclination angle adjustment device. Alternatively, in another way, the inclination angles are fixed, and the inkjet printheads are connected to the inkjet printhead carrier by a manual inclination angle adjustment device (for example, adjusting sheets, adjusting fasteners, etc.).

However, preferably, the inclination angles are designed to be fixed. In such configuration, the inkjet printhead carrier is provided with several mounting grooves which are configured to fix the inkjet printheads; and the center line of each mounting groove defines a third reference line which is inclined at the deflection angle φ relative to the first reference line. The mounting grooves inclined at the deflection angle φ are machined on the inkjet printhead carrier in advance, the inkjet printheads are directly placed into the mounting grooves to achieve that the inkjet printheads can be mounted obliquely at the deflection angle φ relative to the first reference line. Compared with the manner of connecting the inkjet printheads to the inkjet printhead carrier one by one by means of the adjusting sheets or the adjusting fasteners, such way greatly improves the oblique mounting efficiency and precision of the inkjet printheads.

Further, the mounting grooves may include first mounting grooves and second mounting grooves, which are arranged symmetrically each other along the first reference line, the crossing included angle between lower surfaces of the first mounting grooves and lower surfaces of the second mounting grooves defines a mounting included angle θ, and the mounting included angle is θ=180°−2Ø. The two rows of inkjet printheads can be assembled into an inkjet printhead array by staggering and overlapping, and thus the two rows of mounting grooves distributed in parallel are correspondingly arranged. The manner of symmetrically arranging the first mounting grooves and the second mounting grooves along the first reference line is beneficial to simplifying of machining and manufacturing of the inkjet printhead carrier. Furthermore, in a bid to avoid the interference influence on the inkjet process of the inkjet printheads, the lower surfaces of the first mounting grooves and the second mounting grooves are flush with the lower surfaces of the two rows of inkjet printheads respectively, as a result, the lower surfaces of the first mounting grooves and the second mounting grooves are also combined into a recessed surface which is overlapped with the inkjet surface of the inkjet printheads.

Preferably, the inkjet printhead assembly may further include a nozzle cleaning assembly which is mounted on the inkjet printhead carrier according to the present disclosure. The nozzle cleaning assembly includes a negative-pressure suction nozzle and a reciprocating driving mechanism. The negative-pressure suction nozzle abuts against the lower surfaces of the inkjet printheads, and the reciprocating driving mechanism drives the negative-pressure suction nozzle to reciprocate in the lengthwise direction of the inkjet printhead carrier.

According to one embodiment of the present disclosure, the negative-pressure suction nozzle is located below the inkjet printhead carrier, and the upper surface of the negative-pressure suction nozzle is identical with and is in contact with the inkjet surface of the inkjet printheads. The inside of the negative-pressure suction nozzle is in communication with an external negative pressure device, and when the negative pressure device works, the upper surface of the negative-pressure suction nozzle has a suction force. The reciprocating driving mechanism is mounted on the inkjet printhead carrier and drives the negative-pressure suction nozzle to reciprocate in the lengthwise direction of the inkjet printhead carrier. During normal printing, the negative-pressure suction nozzle stays at one end of the inkjet printhead carrier in the lengthwise direction and will not affect normal working of the inkjet printheads. While during cleaning, the reciprocating driving mechanism pushes the negative-pressure suction nozzle to go through all the inkjet printheads in sequence, and the negative-pressure suction nozzle dredges and cleans the nozzle orifices of the inkjet printheads by means of the suction force of the upper surface. With the arrangement of the nozzle cleaning assembly, during cleaning of the inkjet printheads, the inkjet printhead assembly is not required to be dismounted, and the whole cleaning process is automatic, thus greatly improving the working efficiency.

The present disclosure further provides a printing device having a deflection angle. The printing device includes a roller, a linear movement assembly, and the above-mentioned inkjet printhead assembly having the deflection angle. The roller is configured to wind and deliver a printing medium, and the linear movement assembly is configured to drive the inkjet printhead assembly to adjust the distances between the inkjet printhead assembly and a surface of the roller.

Preferably, the roller is located below the linear movement assembly and the inkjet printhead assembly. The vertical center line of the roller defines a fourth reference line. According to one embodiment, four inkjet printhead assemblies and three linear movement assemblies are included. The four inkjet printhead assemblies surround the roller in sequence from left to right at intervals and are arranged symmetrically relative to the fourth reference line. The three linear movement assemblies surround the roller in sequence from left to right at intervals and are arranged symmetrically relative to the fourth reference line. Specifically, the inkjet printhead assembly on the left side (leftmost) is fixedly connected to the linear movement assembly on the left side (leftmost), the inkjet printhead assembly on the right side (rightmost) is fixedly connected to the linear movement assembly on the right side (rightmost), and the two inkjet printhead assemblies in the middle are simultaneously and fixedly connected to the linear movement assembly in the middle. Each linear movement assembly drives the corresponding inkjet printhead assembly independently to adjust the distance between the inkjet printhead assembly and the surface of the roller.

In such configuration, the four inkjet printhead assemblies correspond to CMYK (cyan, magenta, yellow and black) of color printing respectively, that is each inkjet printhead assembly is only responsible for inkjet of one color, so that small number of the inkjet printheads on the inkjet printhead carrier thereof is provided (two rows at least), and thus the machining and manufacturing difficulty of the inkjet printhead carrier is reduced. In addition, the inkjet printhead assemblies on the left side (leftmost) and the right side (rightmost) are separately driven by the linear movement assemblies on the left side (leftmost) and the right side (rightmost) respectively, so that the movement directions of the inkjet printhead assemblies can be overlapped with the first reference lines thereof, that is, the included angles α are zero, and then the included angles α can be prevented from affecting the operation that the inkjet printheads are perpendicular to the surface of the roller for printing. Secondly, the two inkjet printhead assemblies in the middle are simultaneously driven by the linear movement assembly in the middle, so that the number of the linear movement assemblies can be reduced, and the overall size of the printing device thus can be reduced. Of course, in order to ensure the inkjet quality of the two inkjet printhead assemblies in the middle, the included angles α between the movement directions of the nozzle orifices thereof and the first reference lines should be as small as possible. Accordingly, the three linear movement assemblies drive the inkjet printhead assemblies to move to adjust the working heights of the inkjet printhead assemblies during inkjet to meet the requirements of printing media of different thicknesses and different inkjet.

Compared with the prior art, the inkjet printheads in each row are mounted at different inclination angles relative to the inkjet printhead carrier according to the present disclosure, so that the inkjet directions of the inkjet printheads can point to the circle center of the arc-shaped printing surface, and the problem thus can be solved that the multiple rows of staggered and overlapped inkjet printheads cannot be perpendicular to the arc-shaped printing surface simultaneously, thereby achieving the effect of improving the overall printing quality of the inkjet printhead assembly.

### BRIEF DESCRIPTION OF THE DRAWINGS

FIG. 1 is a structure diagram of an inkjet printhead assembly according to a prior art;

FIG. 2 is a schematic diagram of inkjet printheads in staggered and overlapped distribution according to the prior art;

FIG. 3 is a section view of an inkjet printhead assembly according to an embodiment of the present disclosure, in which two rows of inkjet printheads are provided;

FIG. 4 is a section view of an inkjet printhead assembly according to an embodiment of the present disclosure, in which three rows of inkjet printheads are provided;

FIG. 5 is a schematic diagram showing calculation of a deflection angle φ (α=0) of an inkjet printhead having a single row of nozzle orifices according to an embodiment of the present disclosure;

FIG. 6 is a schematic diagram showing calculation of a deflection angle φ (α≠0) of the inkjet printhead having the single row of nozzle orifices according to an embodiment of the present disclosure;

FIG. 7 is a schematic diagram showing calculation of a deflection angle φ (α≠0) of an inkjet printhead having multiple rows of nozzle orifices according to an embodiment of the present disclosure;

FIG. 8 is a section view of an inkjet printhead carrier according to one embodiment;

FIG. 9 is a side view of an inkjet printhead assembly according to an embodiment of the present disclosure;

FIG. 10 is a structure diagram of an inkjet printhead assembly according to an embodiment, from one perspective;

FIG. 11 is a structure diagram of the inkjet printhead assembly of FIG. 10, from another perspective; and

FIG. 12 is a section view of a printing device according to an embodiment.

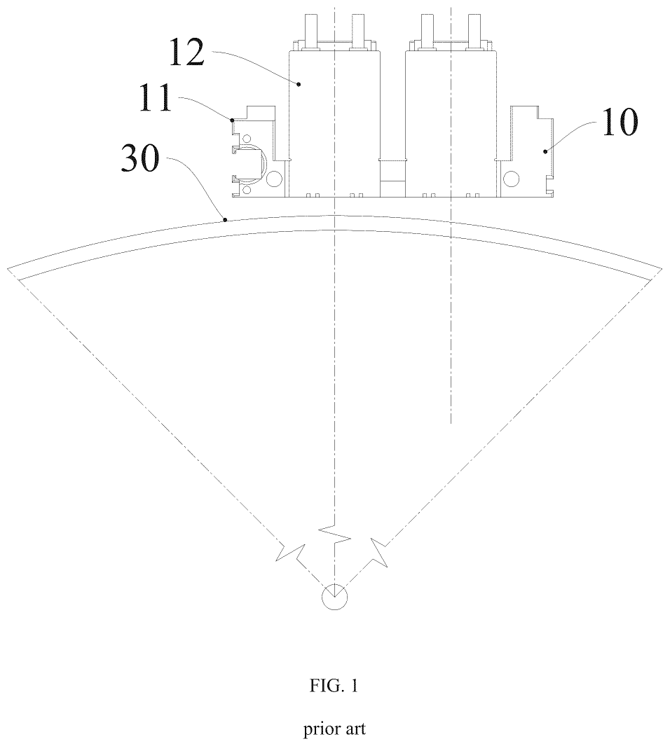

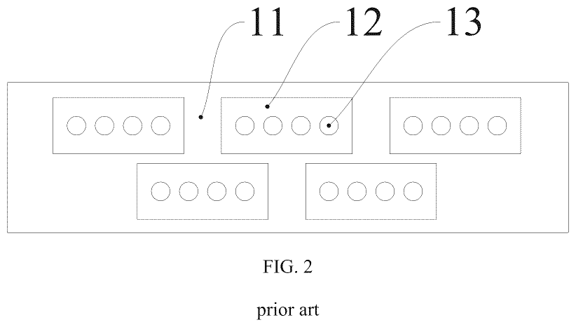

Reference signs: 10 inkjet printhead assembly, 11 inkjet printhead carrier, 12 inkjet printhead, 13 nozzle orifices, 14 first mounting grooves, 15 second mounting grooves, 21 first reference line, 22 second reference line, 23 third reference line, 24 fourth reference line, 30 roller, 40 linear movement assembly, 41 servo motor, 42 lead screw nut, 43 sliding block, 44 guide rail, 45 connecting plate, 50 nozzle cleaning assembly, 51 negative-pressure suction nozzle, 52 reciprocating driving mechanism.

### DETAILED DESCRIPTION OF THE EMBODIMENTS

The drawings of the present disclosure are only used for illustrative description and cannot be understood as limitations on the present disclosure. In order to better describe the following embodiments, some components in the drawings may be omitted, enlarged or reduced, which does not represent the sizes of actual products; and for those skilled in the art, it is understandable that some well-known structures in the drawings and descriptions thereof may be omitted.

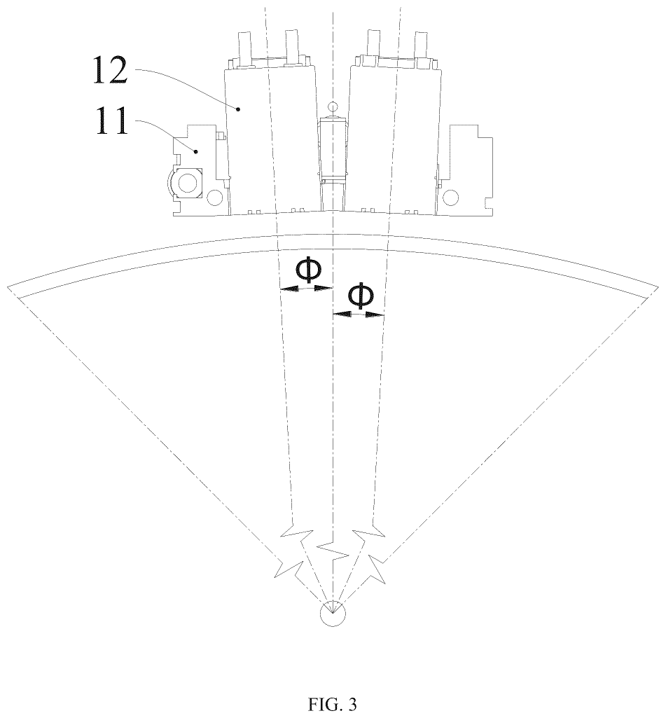

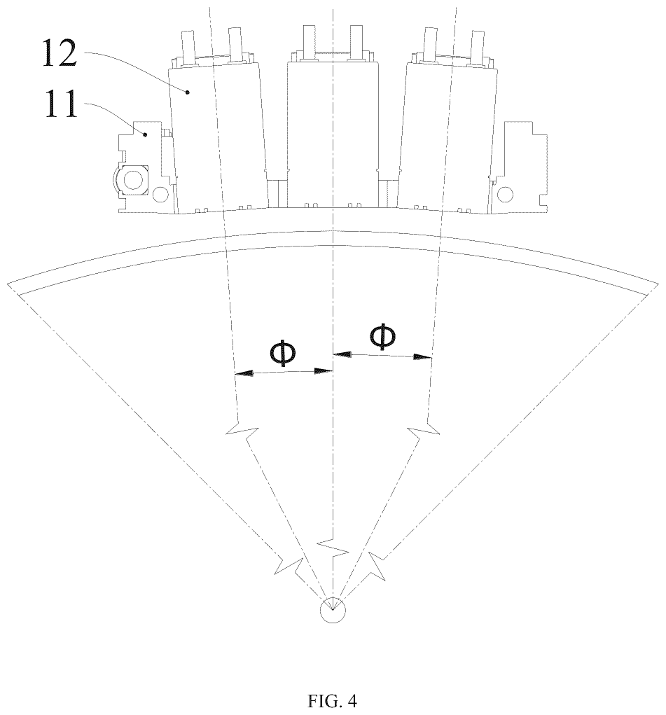

FIGS. 3 and 4 provides an inkjet printhead assembly having a deflection angle according to one embodiment, which includes an inkjet printhead carrier 11 and a plurality of inkjet printheads 12 mounted on the inkjet printhead carrier. The inkjet printheads 12 are distributed in several rows in parallel on the inkjet printhead carrier 11, and the inkjet printheads 12 in the two adjacent rows are staggered and overlapped. The inkjet printheads 12 are mounted obliquely relative to the inkjet printhead carrier 11, and the several rows of inkjet printheads 12 are arranged around an arc-shaped printing surface. Lower surfaces of the several rows of inkjet printheads 12 are combined to form a recessed inkjet surface, and each surface of the combined inkjet surface is tangential with the arc-shaped printing surface.

In this embodiment, a lengthwise direction of the inkjet printhead carrier 11 is a front-and-back direction, a widthwise direction thereof is a left-and-right direction, and a height direction thereof is an upper-and-lower direction. A normal direction at the center of the lower surface of the inkjet printhead 12 is generally taken as the inkjet direction of each inkjet printhead 12. The inkjet printheads 12 in each row are mounted obliquely relative to the inkjet printhead carrier 11, thus the inkjet directions of the inkjet printheads 12 in each row are inclined relative to a certain datum line of the inkjet printhead carrier 11, and the inkjet directions of the inkjet printheads 12 in each row have different inclination angles. The several rows of inkjet printheads 12 are arranged above the arc-shaped printing surface in a surrounding manner. The lower surfaces of the several rows of inkjet printheads 12 are thus no longer in a common plane, and are combined into the recessed inkjet surface. When the inkjet printhead carrier 11 drives the inkjet printheads 12 to get close to the arc-shaped printing surface and the distance between the lower surfaces of the inkjet printheads 12 and the arc-shaped printing surface is zero, each surface of the combined inkjet surface is tangential with the arc-shaped printing surface. The inkjet surface is equivalent to a part of a circumscribed polygon of the arc-shaped printing surface. According to the present embodiment, the inkjet printheads in each row are mounted at different inclination angles relative to the inkjet printhead carrier, so that the inkjet directions of the inkjet printheads can point to the circle center of the arc-shaped printing surface, the problem thus can be solved that the multiple rows of staggered and overlapped inkjet printheads cannot be perpendicular to the arc-shaped printing surface simultaneously, thereby achieving the effect of improving the overall printing quality of the inkjet printhead assembly.

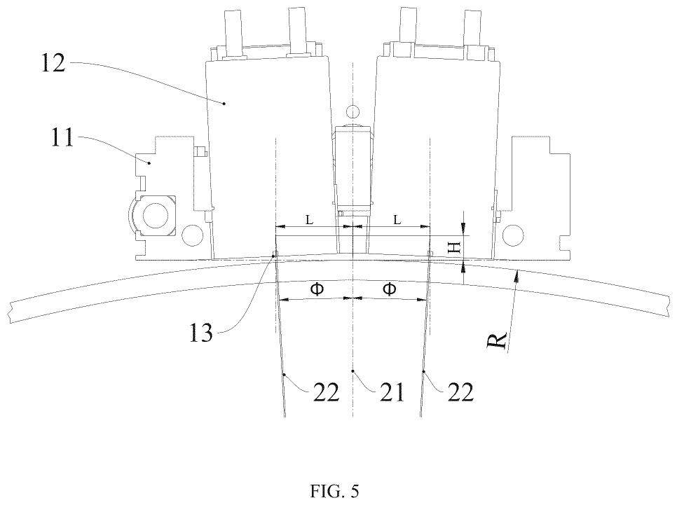

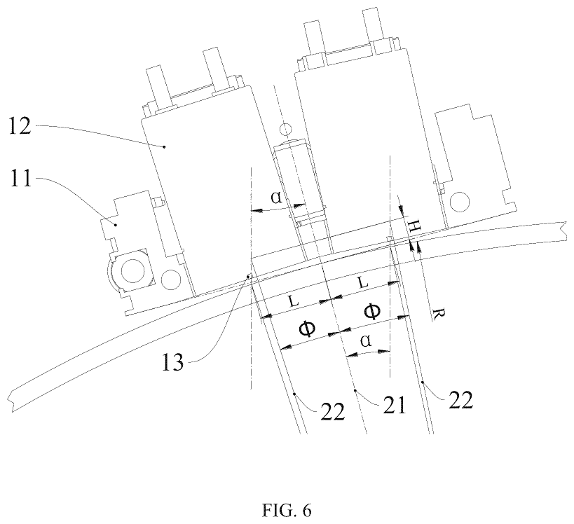

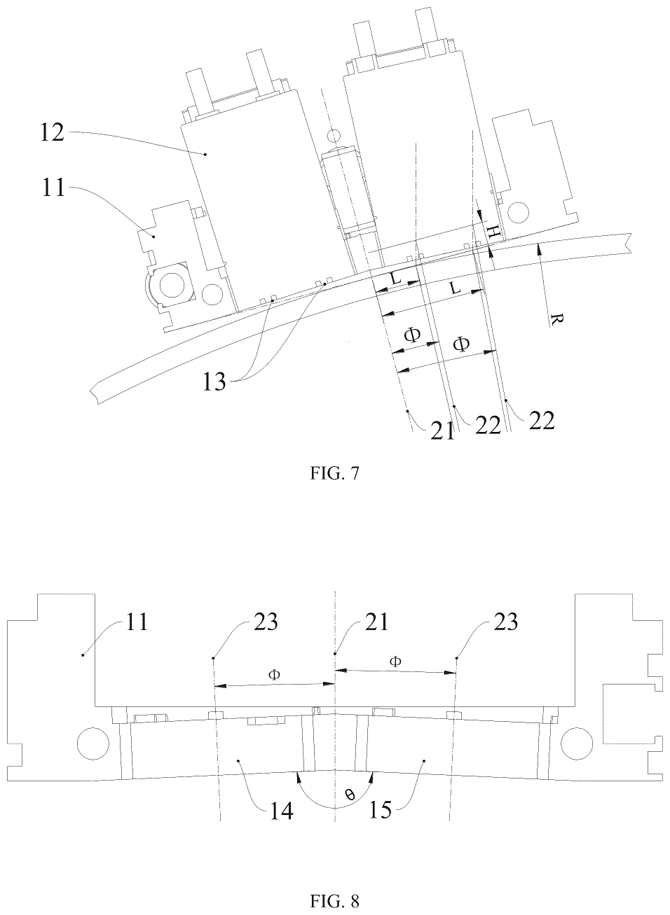

FIGS. 5-7 shows how to define the deflection angle of each inkjet printhead. The specific numerical values of the inclination angle or deflection angle can be obtained by means of the simplified relationship of the inkjet printhead carrier 11 and each inkjet printhead 12. The inkjet printhead carrier 11 has a first reference line 21 which points to the circle center of the arc-shaped printing surface, and nozzle orifices 13 of each of the inkjet printheads 12 have a second reference line 22 which points to an inkjet direction of the nozzle orifices 13. The included angle between the first reference line 21 and the second reference line 22 defines the deflection angle φ, and the inkjet printheads 12 are mounted obliquely at the deflection angle φ relative to the first reference line 21.

A calculation formula for the deflection angle φ is as follows:

$$φ = {tan}^{- 1} \frac{L + H tan a}{R + H} ,$$

wherein L refers to the distance between the nozzle orifices and the first reference line; H refers to the height from the inkjet printhead carrier to the arc-shaped printing surface; α refers to the included angle between a movement direction of the nozzle orifices and the first reference line; and R refers to the radius of the arc-shaped printing surface.

In this embodiment, the first reference line 21 of the inkjet printhead carrier 11 is used as the datum line, which can be the center line of the inkjet printhead carrier 11. When the inkjet printheads 12 are mounted obliquely at the deflection angle φ relative to the first reference line 21 of the inkjet printhead carrier 11, all that is required to ensure that the inkjet directions of the inkjet printheads 12 in each row point to the circle center of the arc-shaped printing surface is to make the first reference line 21 point to the circle center of the arc-shaped printing surface, in such way the inkjet printheads 12 in each row are ensured to be perpendicular to the arc-shaped printing surface simultaneously. The second reference line 22 starts from the center of the nozzle orifices 13 of each inkjet printhead 12 and points to the inkjet direction of the nozzle orifices 13. When the single inkjet printhead 12 has a single row of nozzle orifices 13, the second reference line 22 is the inkjet direction of the inkjet printheads 12 in the row, and the deflection angle φ is the inclination angle at which the inkjet printheads 12 in the row are mounted relative to the inkjet printhead carrier 11. When the single inkjet printhead 12 has multiple rows of nozzle orifices 13, each row of the nozzle orifices 13 has one second reference line 22, and thus a plurality of deflection angles φ are calculated. Since the distances of the multiple rows of nozzle orifices 13 are short, the average value of the deflection angles φ of the multiple rows of nozzle orifices 13 or the deflection angle φ of the middle of the multiple rows of nozzle orifices 13 can be calculated as the inclination angle at which the inkjet printheads 12 in the row are mounted relative to the inkjet printhead carrier 11. Therefore, within the allowable range of errors, the inkjet directions of the multiple rows of nozzle orifices 13 of the inkjet printheads 12 in the row are nearly perpendicular to the arc-shaped printing surface.

As the height H from the inkjet printhead carrier to the arc-shaped printing surface may change in a certain range, for the inkjet printheads 12 in each row, a plurality of deflection angles φ can be calculated. However, the height H and the radius R of the arc-shaped printing surface differ by several orders of magnitude, the deflection angles φ thus change slightly, accordingly, within the allowable range of errors, the average value thereof can be taken as the inclination angle at which the inkjet printheads 12 in the row are mounted relative to the inkjet printhead carrier 11. When the height H from the inkjet printhead carrier and the arc-shaped printing surface is zero, a lower surface of the inkjet printhead carrier 11 and an imaginary extension surface thereof are tangential with the arc-shaped printing surface. The height H from the inkjet printhead carrier and the arc-shaped printing surface is equivalent to the working height of the inkjet printheads 12. Therefore, the distance L between the nozzle orifices and the first reference line should be the numerical value when the height H from the inkjet printhead carrier and the arc-shaped printing surface is zero. Besides, when the height H of the inkjet printhead carrier 11 is adjusted, the inkjet printhead carrier 11 will not necessarily move along the first reference line 21 thereof. Therefore, when the included angle α between the movement direction of the nozzle orifices and the first reference line is formed on the outer side of the arc-shaped printing surface, the included angle α is a negative value; and when the included angle α between the movement direction of the nozzle orifices and the first reference line is formed on the inner side of the arc-shaped printing surface, the included angle α is a positive value.

Preferably, the ratio of the radius R of the arc-shaped printing surface to the distance L between the nozzle orifices 13 and the first reference line 21 is as follows: R/L≥10. For the inkjet printheads 12 having multiple rows of nozzle orifices 13, the distances L between the nozzle orifices and the first reference line include the minimum value L_{MIN} and the maximum value L_{MAX}. When the ratio of R to L is calculated, the distance L should be L_{MAX}; and further, the following should be met: R/(L_{MAX}−L_{MIN})≥20. On one hand, when the ratio of R to L differs by one order of magnitude, the difference of the numerical value of the calculated deflection angle φ of each row of the nozzle orifices 13 of the single inkjet printhead 12 is small, and thus the average value of the deflection angles φ of the multiple rows of nozzle orifices 13 or the deflection angle φ of the middle of the multiple rows of nozzle orifices 13 can be calculated as the inclination angle at which the inkjet printheads 12 in the row are mounted relative to the inkjet printhead carrier 11. Therefore, within the allowable range of errors, the inkjet directions of the multiple rows of nozzle orifices 13 of the inkjet printheads 12 in the row are nearly perpendicular to the arc-shaped printing surface. On the other hand, when the ratio of R to L differs by one order of magnitude, the distance of each row of nozzle orifices 13 of the single inkjet printhead 12 is also correspondingly small, thus the height of each row of nozzle orifices 13 relative to the arc-shaped printing surface can be nearly equal, and thus the influence of the curvature of the arc-shaped printing surface on the inkjet quality of the inkjet printheads 12 can be reduced.

Preferably, the numerical value of the included angle between the movement direction of the inkjet printhead carrier 11 and the first reference line 21 is as follows: |α|≤20°. When the inkjet printhead carrier 11 is located at different heights H, the included angle α will affect the actual distance between the nozzle orifices 13 of the inkjet printheads 12 and the first reference line 21. When the included angle α is the positive value, the included angle α will increase the actual distance between the nozzle orifices 13 and the first reference line 21; and when the included angle α is the negative value, the included angle α will shorten the actual distance between the nozzle orifices 13 and the first reference line 21. Such influence will be increased with increase of the numerical value of the included angle α. Therefore, in the actual application, the numerical value of the included angle α should not exceed 20°, and the value range of the included angle α should be [−20°, 20° ].

Preferably, the deflection angle φ is in a range of 1° to 5°. According to the calculation formula of the deflection angle φ, the deflection angle φ is comprehensively affected by the distance L, the height H, the included angle α and the radius R. When the deflection angle φ of the nozzle orifices 13 of the inkjet printheads 12 relative to the first reference line 21 is in the range of 1° to 5°, the influence on the inclination angles of the inkjet printheads 12 can be reduced that caused by the working height of the inkjet printhead carrier 11 and the distribution condition of the nozzle orifices 13 of the inkjet printheads 12. For example, for the inkjet printheads 12 having the multiple rows of nozzle orifices 13, when the inkjet printheads 12 are mounted obliquely at 3° relative to the inkjet printhead carrier 11, within the error range of 2°, any row of the nozzle orifices 13 of the inkjet printheads 12 can be deemed as perpendicular to the arc-shaped printing surface at any working height, and the inkjet directions thereof point to the circle center of the arc-shaped printing surface.

The inkjet printheads 12 may be mounted obliquely relative to the inkjet printhead carrier 11 in a way that the inclination angles therebetween are changing, that is, the inclination angles of the inkjet printheads 12 relative to the inkjet printhead carrier 11 can change with the deflection angle in different situations, and the inkjet printheads 12 are connected to the inkjet printhead carrier 11 by an automatic inclination angle adjustment device. Alternatively, the inclination angles can also be fixed, and the inkjet printheads 12 are connected to the inkjet printhead carrier 11 by a manual inclination angle adjustment device (for example, adjusting sheets, adjusting fasteners, etc.).

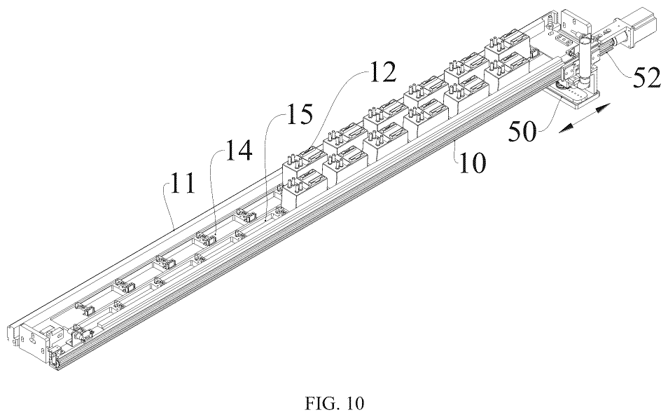

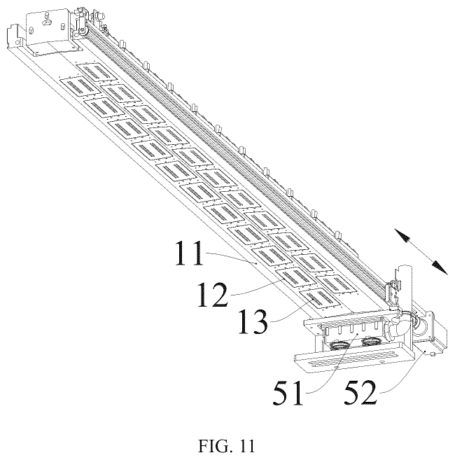

As shown in FIGS. 8-11, preferably, the inclination angles are designed to be fixed. In such configuration, the inkjet printhead carrier 11 is provided with several mounting grooves which are configured to fix the inkjet printheads 12, and the center line of each mounting groove defines a third reference line 23 which is inclined at the deflection angle φ relative to the first reference line 21. The mounting grooves inclined at the deflection angle φ are machined on the inkjet printhead carrier 11 in advance, so that the inkjet printheads 12 are directly placed into the mounting grooves to achieve that the inkjet printheads 12 can be mounted obliquely at the deflection angle φ relative to the first reference line 21. Compared with the manner of connecting the inkjet printheads 12 to the inkjet printhead carrier one by one by means of the adjusting sheets or the adjusting fasteners, such manner greatly improves the oblique mounting efficiency and precision of the inkjet printheads 12.

Specifically, the mounting grooves includes first mounting grooves 14 and second mounting grooves 15, which are arranged symmetrically each other along the first reference line 21, the crossing included angle between lower surfaces of the first mounting grooves 14 and lower surfaces of the second mounting grooves 15 is a mounting included angle θ, and the mounting included angle is as follows: θ=180°−2Ø. The two rows of inkjet printheads 12 can be assembled into an inkjet printhead 12 array by staggering and overlapping, and thus the two rows of mounting grooves distributed in parallel are correspondingly arranged. The manner of symmetrically arranging the first mounting grooves 14 and the second mounting grooves 15 along the first reference line 21 is beneficial to simplifying of machining and manufacturing of the inkjet printhead carrier 11. Furthermore, in a bid to avoid the interference influence on the inkjet process of the inkjet printheads 12, the lower surfaces of the first mounting grooves 14 and the second mounting grooves 15 are flush with the lower surfaces of the two rows of inkjet printheads 12 respectively, and thus the lower surfaces of the first mounting grooves 14 and the second mounting grooves 15 are also combined into a recessed surface which is overlapped with the inkjet surface of the inkjet printheads 12.

In this embodiment, there are two rows of inkjet printheads 12 and two rows of mounting grooves, which are arranged symmetrically relative to the first reference line 21 of the inkjet printhead carrier 11. The single inkjet printhead 12 has four rows of nozzle orifices 13, and the specific model is XAAR2001-GS12C. The inkjet printheads 12 are mounted obliquely at the deflection angle φ=2.56° relative to the first reference line 21 of the inkjet printhead carrier 11. Correspondingly, the radius of the arc-shaped printing surface is 570 mm, the width of the inkjet printheads 12 is 50 mm, and the mounting included angle θ between the first mounting grooves 14 and the second mounting grooves 15 is 174.88°. The plurality of inkjet printheads 12 are mounted one by one in the first mounting grooves 14 and the second mounting grooves 15 by means of the fasteners. Additionally, in other embodiments, three rows of inkjet printheads 12 may be arranged in parallel, and the center line of the inkjet printheads 12 in the middle row is overlapped with the first reference line 21.

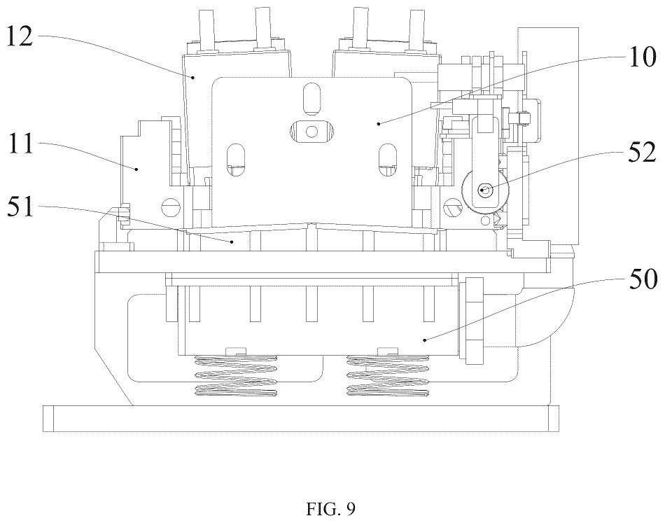

As shown in FIGS. 9-11, additionally or alternatively, the inkjet printhead assembly further includes a nozzle cleaning assembly 50 which is mounted on the inkjet printhead carrier 11. The nozzle cleaning assembly 50 has a negative-pressure suction nozzle 51 and a reciprocating driving mechanism 52. The negative-pressure suction nozzle 51 abuts against the lower surfaces of the inkjet printheads 12, and the reciprocating driving mechanism 52 drives the negative-pressure suction nozzle 51 to reciprocate in the lengthwise direction of the inkjet printhead carrier 11.

In this embodiment, the negative-pressure suction nozzle 51 is located below the inkjet printhead carrier 11, and the upper surface of the negative-pressure suction nozzle 51 is identical with and is in contact with the inkjet surface of the inkjet printheads 12. The inside of the negative-pressure suction nozzle 51 is in communication with an external negative pressure device, and when the negative pressure device works, the upper surface of the negative-pressure suction nozzle 51 has a suction force. The reciprocating driving mechanism 52 is mounted on the inkjet printhead carrier 11 and drives the negative-pressure suction nozzle 51 to reciprocate in the lengthwise direction of the inkjet printhead carrier 11. During normal printing, the negative-pressure suction nozzle 51 stays at one end of the inkjet printhead carrier 11 in the lengthwise direction and does not affect normal working of the inkjet printheads 12. While during cleaning, the reciprocating driving mechanism 52 pushes the negative-pressure suction nozzle 51 to go through all the inkjet printheads 12 in sequence, and the negative-pressure suction nozzle 51 dredges and cleans the nozzle orifices 13 of the inkjet printheads 12 by means of the suction force of the upper surface. With the arrangement of the nozzle cleaning assembly 50, during cleaning of the inkjet printheads 12, the inkjet printhead assembly is not required to be dismounted, and the whole cleaning process is automatic, thus greatly improving the working efficiency.

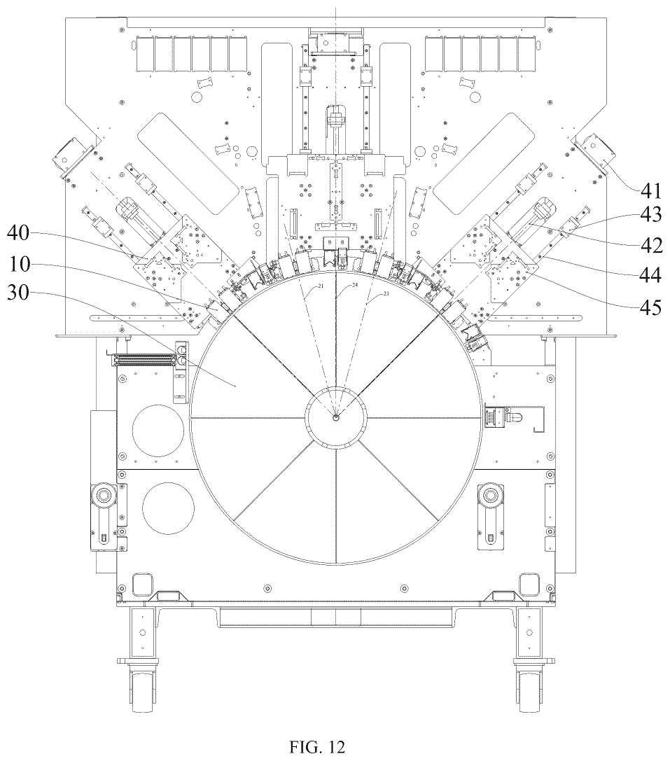

FIG. 12 shows a printing device having a deflection angle according to one embodiment. The printing device includes a roller 30, a linear movement assembly 40, and an inkjet printhead assembly 10 having the deflection angle as above-mentioned. The roller 30 is configured to wind and deliver a printing medium, and the linear movement assembly 40 is configured to drive the inkjet printhead assembly 10 to adjust the distances between the inkjet printhead assembly 10 and a surface of the roller 30.

Preferably, the roller 30 is located below the linear movement assembly 40 and the inkjet printhead assembly 10. The vertical center line of the roller 30 defines a fourth reference line 24. As FIG. 12 shown, in this embodiment, four inkjet printhead assemblies 10 and three linear movement assemblies 40 are included. The four printing nozzle assemblies 10 surround the roller 30 in sequence from left to right at intervals and are arranged symmetrically relative to the fourth reference line 24. The three linear movement assemblies 40 surround the roller 30 in sequence from left to right at intervals and are arranged symmetrically relative to the fourth reference line 24. Specifically, the inkjet printhead assembly 10 on the left side (leftmost) is fixedly connected to the linear movement assembly 40 on the left side (leftmost), the inkjet printhead assembly 10 on the right side (rightmost) is fixedly connected to the linear movement assembly 40 on the right side (rightmost), and the two inkjet printhead assemblies 10 in the middle are simultaneously and fixedly connected to the linear movement assembly 40 in the middle. Each linear movement assembly 40 drives the corresponding inkjet printhead assembly 10 independently to adjust the distance between the inkjet printhead assembly 10 and the surface of the roller 30.

In this embodiment, the four inkjet printhead assemblies 10 correspond to CMYK (cyan, magenta, yellow and black) of color printing respectively, that is, each inkjet printhead assembly 10 is only responsible for inkjet of one color, so that small number of the inkjet printheads 12 on the inkjet printhead carrier 11 thereof is provided (two rows at least), and thus the machining and manufacturing difficulty of the inkjet printhead carrier 11 is reduced. In addition, the inkjet printhead assemblies 10 on the left side (leftmost) and the right side (rightmost) are separately driven by the linear movement assemblies 40 on the left side (leftmost) and the right side (rightmost) respectively, so that the movement directions of the inkjet printhead assemblies 10 can be overlapped with the first reference lines 21 thereof, that is, the included angles α are zero, and then the included angles α can be prevented from affecting the operation that the inkjet printheads 12 are perpendicular to the surface of the roller 30 for printing. Secondly, the two inkjet printhead assemblies 10 in the middle are simultaneously driven by the linear movement assembly 40 in the middle, so that the number of the linear movement assemblies 40 can be reduced, and the overall size of the printing device thus can be reduced. Of course, in order to ensure the inkjet quality of the two inkjet printhead assemblies 10 in the middle, the included angles α between the movement directions of the nozzle orifices thereof and the first reference lines should be as small as possible. Accordingly, the three linear movement assemblies 40 drive the inkjet printhead assemblies 10 to move to adjust the working heights of the corresponding inkjet printhead assemblies 10 during inkjet to meet the requirements of printing media of different thicknesses and different inkjet.

In this embodiment, each of the inkjet printhead assemblies 10 is of the structure as shown in Embodiment 1, and the radius of the corresponding roller 30 is 570 mm. The inkjet printhead assemblies 10 surround the roller 30 in sequence at intervals of 30°. The included angles between each of the first reference lines 21 of the two inkjet printhead assemblies 10 in the middle and the fourth reference line 24 of the roller 30 are 15°.

In this embodiment, each of the linear movement assemblies 40 further includes a servo motor 41, a lead screw nut 42, etc. for providing power, and sliding blocks 43, guide rails 44, a connecting plate 45, etc. for providing supporting. The axe of each lead screw nut, namely, the center line of each linear movement assembly 40 points to the circle center of the roller 30. The three linear movement assemblies 40 surround the roller 30 in sequence at intervals of 45°, and the center line of the linear movement assembly 40 in the middle is overlapped with the fourth reference line 24 of the roller 30. In addition, each of the inkjet printhead assemblies 10 on the left side and the right side is mounted centrally at the lower portion of the connecting plate 45 of the respective linear movement assembly 40 on the left side and the right side by means of fasteners, and the first reference lines 21 of the inkjet printhead carriers 11 thereof are overlapped with the center lines of the linear movement assemblies 40. The two inkjet printhead assemblies 10 in the middle are simultaneously mounted at a lower portion of the connecting plate 45 of the linear movement assembly 40 in the middle by means of fasteners, and included angles of 15° are formed between the first reference lines 21 of the inkjet printhead carriers 11 thereof and the center line of the linear movement assembly 40.

In this embodiment, an outer surface of the roller 30 is provided with a plurality of air holes, the inside of the roller 30 is in communication with the external negative pressure device, and the printing medium is adsorbed onto the outer surface of the roller 30 by means of the air holes under the negative pressure. The axial end of the roller 30 is connected to a driving device (for example, an electric motor). After the roller 30 delivers the printing medium to enter a printing area for printing, the air holes in the roller 30 are connected to the negative pressure, and then the printing medium is adsorbed onto the outer surface of the roller; and after the roller 30 delivers the printing medium to leave the printing area and the air holes in the roller 30 lose the negative pressure, the printing medium is wound around the surface of the roller by means of the tension of the printing medium. Refer to a printer roller having a negative pressure adsorption function in Chinese patent No. 202110615060.4 for the specific structure of the roller 30.

Obviously, the above-mentioned embodiments of the present disclosure are only examples to clearly describe the technical solutions of the present disclosure, and are not intended to limit the particular embodiments of the present disclosure. Any modification, equivalent replacement and improvement made within the spirit and principles of the claims of the present disclosure should fall within the scope of protection of the claims of the present disclosure.

What is claimed is:

1. An inkjet printhead assembly having a deflection angle, comprising:
an inkjet printhead carrier; and
a plurality of inkjet printheads mounted on the inkjet printhead carrier, the plurality of inkjet printheads being distributed in several rows in parallel on the inkjet printhead carrier, and the inkjet printheads in the two adjacent rows being in staggered and overlapped arrangement,
wherein the plurality of the inkjet printheads are mounted obliquely relative to the inkjet printhead carrier, and the plurality of the inkjet printheads are arranged around an arc-shaped printing surface; lower surfaces of the plurality of the inkjet printheads are combined to form a recessed inkjet surface, and each surface of the recessed inkjet surface is tangential with the arc-shaped printing surface.

2. The inkjet printhead assembly according to claim 1, wherein the inkjet printhead carrier has a first reference line which points to a circle center of the arc-shaped printing surface, nozzle orifices of each of the inkjet printheads have a second reference line which points to an inkjet direction of the nozzle orifices, an included angle between the first reference line and the second reference line is a deflection angle φ, and the inkjet printheads are mounted obliquely at the deflection angle φ relative to the first reference line, and
wherein a calculation formula for the deflection angle φ is
$$φ = {tan}^{- 1} \frac{L + H tan a}{R + H} ;$$
L refers to a distance between the nozzle orifices and the first reference line;
H refers to a height from the inkjet printhead carrier to the arc-shaped printing surface;
α refers to an included angle between a movement direction of the nozzle orifices and the first reference line; and
R refers to a radius of the arc-shaped printing surface.

3. The inkjet printhead assembly according to claim 2, wherein the ratio of the radius R of the arc-shaped printing surface to the distance L between the nozzle orifices and the first reference line satisfies R/L≥10.

4. The inkjet printhead assembly according to claim 2, wherein a numerical value of the included angle between a movement direction of the inkjet printhead carrier and the first reference line is |α|≤20°.

5. The inkjet printhead assembly according to claim 2, wherein the deflection angle φ is in a range of 1° to 5°.

6. The inkjet printhead assembly according to claim 2, wherein the inkjet printhead carrier is provided with several mounting grooves which are configured to fix the plurality of inkjet printheads, and a center line of each mounting groove defines a third reference line which is inclined at the deflection angle φ relative to the first reference line.

7. The inkjet printhead assembly according to claim 6, wherein the mounting grooves comprise first mounting grooves and second mounting grooves which are arranged symmetrically each other along the first reference line, a crossing included angle between lower surfaces of the first mounting grooves and lower surfaces of the second mounting grooves defines a mounting included angle θ, and the mounting included angle is θ=180°−2Ø.

8. The inkjet printhead assembly according to claim 2, further comprising a nozzle cleaning assembly mounted on the inkjet printhead carrier, which comprises:
a negative-pressure suction nozzle, the negative-pressure suction nozzle being abutted against lower surfaces of the inkjet printheads; and
a reciprocating driving mechanism, which is configured to drive the negative-pressure suction nozzle to reciprocate in a lengthwise direction of the inkjet printhead carrier.

9. A printing device having a deflection angle, comprising:
a roller, configured to wind and deliver a printing medium;
a linear movement assembly; and
the inkjet printhead assembly according to claim 1, which is driven by the linear movement assembly to adjust a distance between the inkjet printhead assembly and a surface of the roller.

10. The printing device according to claim 9, wherein the roller is located below the linear movement assembly and the inkjet printhead assembly, and a vertical center line of the roller defines a fourth reference line;
wherein four inkjet printhead assemblies and three linear movement assemblies are included, the four inkjet printhead assemblies surround the roller in sequence from left to right at intervals and are arranged symmetrically relative to the fourth reference line, and the three linear movement assemblies surround the roller in sequence from left to right at intervals and are arranged symmetrically relative to the fourth reference line;
the inkjet printhead assembly on the left side is fixedly connected to the linear movement assembly on the left side, the inkjet printhead assembly on the right side is fixedly connected to the linear movement assembly on the right side, and the two inkjet printhead assemblies in the middle are simultaneously connected to the linear movement assembly in the middle; and
each linear movement assembly drives the respective inkjet printhead assembly independently to adjust the distance between the respective inkjet printhead assembly and the surface of the roller.
